(19) United States
(12) Patent Application Publication
(10) Pub. No.: US 2007/0213455 A1
(43) Pub. Date: Sep. 13, 2007

(54) Silicone compositions for high voltage insulator

(76) Inventors: Jayantha Amarasekera, Clifton Park, NY (US); James Edward Doin, Hoosick Falls, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/648,909

(22) Filed: Jan. 3, 2007

Related U.S. Application Data
(63) Continuation of application No. 09/000,824, filed on Dec. 30, 1997, now abandoned.

(51) Int. Cl. C08L 83/04

(52) U.S. Cl. 524/588

(57) ABSTRACT

The present invention discloses a composition comprising a silicone polymer, a reinforcing filler, an anti-tracking agent and a flame retardant, a coupling agent, a curing agent an extending filler; and at least one processing fluid. These compositions, upon curing, are useful as High Voltage Insulators (HVI) with out door applications.

### FIELD OF INVENTION

The present invention is related to heat-cured rubber silicone compositions suitable for out-door high voltage insulator applications.

### BACKGROUND OF THE INVENTION

High voltage insulators (HVI), such as those used in power transmission lines, distribution stations, surge arrests, etc., are generally made of porcelain or glass. HVI's, when used in a contaminated environment such as an area extending along the seaside or in an industrial district, deteriorate causing current leakage, or dry band discharge leading to flashovers.

Composite (non-ceramic) material has become a leading candidate for out-door high voltage insulators replacing traditional ceramic insulators. Silicone rubber has become a popular material for these types of insulators mainly due to its hydrophobicity even when the surface is covered with contaminants. Furthermore, the polymeric insulators of this type have the advantage of being light weight.

A silicone insulator consists of two basic components—a structural component (core) and a weather shed component. The structural component is a glass-fiber reinforced resin rod of high mechanical strength. The uninsulated structural component is not suitable for outdoor high-voltage applications since in the presence of high voltage, contamination, and moisture the uninsulated structural component is susceptible to tracking. Therefore, weather sheds made from silicone rubber are fitted over the structural component to provide maximum insulation. These encapsulating silicone weather sheds are placed on the rod as a single piece by direct injection or transfer molding processes where silicone rubber is injected on to the rod and shaped. Some fabricators make use of a modular process where silicone rubber is first extruded over the rod to make a sheath and individual sheds are then assembled over the sheath to complete the insulator. Therefore silicone rubber products used in these applications should posses good processability during these insulator fabrication processes.

There is thus a need for silicone compositions having adequate physical strength to resist damage during shipping and field installation, good thermal stability, resistance to electrical tracking and erosion, hydrolysis, ultraviolet degradation and capable of maintaining water repellency. Moreover, these materials should perform well in aforementioned molding processes during the insulator fabrication.

### SUMMARY OF THE INVENTION

The present invention provides a composition comprising:
(a) from about 15% to about 50%, by weight of the total composition, of a silicone polymer;
(b) from about 5% to about 30% by weight of the total composition of a reinforcing filler;
(c) from about 20% to about 70% by weight of the total composition of an anti-tracking agent and a flame retardant;
(d) from about 0.01% to about 1% by weight of the total composition of a coupling agent;
(e) from about 0.1% to about 5% by weight of the total composition of a curing agent;
(f) up to about 20% by weight of the total composition of an extending filler; and
(g) from about 0.1% to about 5% by weight of the total composition of at least one processing fluid.

### DETAILED DESCRIPTION

Preferred embodiments of the present invention provide compositions comprising: (a) from about 15% to about 50%, by weight of the total composition, of a silicone polymer; (b) from about 5% to about 30% by weight of the total composition of a reinforcing filler; (c) from about 20% to about 70% by weight of the total composition of an anti-tracking agent and a flame retardant; (d) from about 0.01% to about 1% by weight of the total composition of a coupling agent; (e) from about 0.1% to about 5% by weight of the total composition of a curing agent; (f) up to about 20% by weight of the total composition of an extending filler; and (g) from about 0.1% to about 5% by weight of the total composition of at least one processing fluid.

A further preferred embodiment provides a composition wherein: (a) the silicone polymer comprises from about 25% to about 40%; (b) the reinforcing filler comprises from about 8% to about 20%; and (c) the anti-tracking and the flame retardant comprises from about 25% to about 60%.

The silicone polymer used in the compositions of the present invention is represented by recurring units of Formula I: 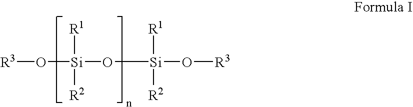
wherein, R¹ independently at each occurrence represents C₁₋₄ alkyl, or C₂₋₄ alkylene; R² independently at each occurrence represents C₁₋₄ alkyl, C₁-C₄ haloalkyl, or C₂₋₄ alkylene; R³ independently at each occurrence represents H, C₁₋₁₀ alkyl, C₂₋₄ alkylene, C₄₋₆ cycloalkyl, OH, C₁-C₄ haloalkyl; and n represents an integer from 1,000 to 20,000.

A further preferred composition comprises a silicone polymer wherein, R¹ independently at each occurrence represents, CH₃, or CH═CH₂; R² independently at each occurrence represents, CH₃, CH═CH₂, or CH₂CH₂CF₃; R³ independently at each occurrence represents CH₃, CH═CH₂, OH, or CH₂CH₂CF₃; and n represents an integer from about 4,000 to about 10,000.

Another embodiment provides a composition wherein the vinyl content of the silicone polymer ranges from about 0.05% to about 0.5% by weight of the silicone polymer. Yet another embodiment provides a composition wherein the reinforcing filler is fumed silica, precipitated silica, or carbon black having a surface area of from about 50 to about 400 m²/g. Preferred coupling agent used in the compositions of the present invention is vinyltriethoxysilane (VTES), or vinyltrimethoxysilane, methacrylpropyltrimethoxy silane.

Provided by the present invention are compositions wherein the curing agent is a peroxide based curing agent, preferably the curing agent is a diacylperoxide, ketone peroxide, or dialkyl peroxide. Also provided are compositions wherein the extending filler is ground quartz, calcium carbonate, magnesium silicate, or magnesium aluminum silicate; the processing fluid is a methyl or hydroxy terminated polydimethyl siloxane.

A further preferred composition comprises at least one of a mold release agent, a coloring agent, and a heat resistive agent. Preferred mold release agent is a silicone fluid, magnesium, aluminum, or cerium stearate, and a preferred heat resistive agent is a cerium octoate, cerium hydroxide, magnesium oxide, cerium oxide, or magnesium hydroxide.

Also provided by the present invention is a composition wherein upon heat curing the composition, the heat cured composition comprises a high voltage insulating composition. Another embodiment of the present invention provides a process for making a high voltage insulating composition, the process comprising heat curing the compositions of the present invention.

The compositions disclosed in this invention provide silicone rubber compositions, which upon heat curing are converted to rubbery elastomers superior in high voltage electrical insulating characteristics such as resistance to weather, erosion, tracking and arc under severe contaminative or weather conditions.

These are prepared by mixing vinyl containing polydimethylsiloxane gums with Alumina Trihydrate (ATH), fumed silica, and Minusil (ground quartz) in the presence of silicone processing fluids and silane coupling agents. These formulations optionally contain mold release agents, flame retardant, and coloring pigments. The products can be cured using standard peroxides at elevated temperatures and be converted to insulators of different shapes either by compression, injection or transfer molding processes. The products made from these formulations showed very good tracking/erosion resistance and fast hydrophobicity recovery which are critical to the longevity performance of high voltage insulators.

The diorganopolysiloxane used in these formulations is a polysiloxane having at least a two silicon atom-bonded alkenyl group per one molecule. Illustrative examples of such alkenyl groups are vinyl, allyl, or propynyl. The structure of the polysiloxane polymer may be either linear structure or branched one, however, polymers with linear structure are preferred. The molecular weight of the polymer is not limited and any of those called organopolysiloxane gum in the industry are employable. Usually an organopolysiloxane gum having viscosity at 25 C of higher than 10⁶ centistokes and with average molecular weight larger than 5×10⁴, preferably not less than 30×10⁴ may be used.

The processing fluid is a alkylpolysiloxane oil or phenylpolysiloxane oil which is capped with hydroxyl, allyl or phenyl groups at both terminal ends of the molecular chain. This oil is added to facilitate the mixing of polymers with fillers during the compounding process. The advantage of using these fluids is that the low molecular weight fragments present in these compounds continuously move to the surface shortening the time required for recovery of water repellency (hydrophobicity). Accordingly, the performance of the insulator material, particularly, the effects of preventing corona noise and flash-over in the polluted environment last for a long time.

Alumina trihydrate (ATH, also commonly known as aluminum hydroxide to one skilled in the art) improves the arc resistance and the flame retardancy of the instantly claimed composition. ATH is a compound represented by the chemical formula of Al₂O₃.3H₂0 or Al(OH)₃. ATH with a particle size of less than about 10 microns being preferred. If the blended amount of ATH is too small, arc resistance necessary for prolonged use of the insulator is lost, where as if the blended amount is too large, the processability of the present compositions in making insulator parts is adversely affected. The amount of ATH is hence preferably in the range of about 15 to about 300 parts by weight of 100 parts of organopolysiloxane polymer or polymer mixture, and more preferably in the range 50-200 parts of polymer.

The fumed silica fine powder is added to these compositions to improve the strength of silicone rubber. Fumed silica having a average particle size of not more than 50 microns and a specific surface area of not less than about 100 m²/g is preferred. A smaller average particle size is preferred since it gives a higher surface area resulting in better reinforcing properties. Furthermore, surface-treated silica, for example, hydrophobic silica surface treated with organosiloxane(s), hexaorganodisilazane or diorganocyclopolysiloxane further enhance filler reinforcing properties. If the amount of fumed silica used in these formulations is too small, the mechanical strength of the silicone rubber will be deteriorated, while if it is too large, it hinders the effective use of a higher proportion of ATH. The amount of fumed silica used is generally in the range of about 10 to about 100, preferably in the range 20-80, parts by weight, based on 100 parts of silicone gums.

A second type of filler, a non-reinforcing filler, is also used in the compositions of the present invention. This filler facilitates good mixing of fumed silica and ATH with polyorganosiloxane polymers and provides compositions with well dispersed filler contents. Improper dispersion of ATH is in these compositions leads to premature tracking and erosion failures and the insulator life time is shortened. Preferred fillers are essentially electrically non-conducting ground quartz. Quartz also has good thermal conductivity properties and provides good heat transfer during the molding of these compositions, making molding cycles shorter.

An organosilane coupling agent, as used in the compositions of the present invention, act as (a) surface modifier for fumed silica and ATH, and (b) as a cross linker for the coupling between fumed silica and ATH with siloxane polymers. By having a coupling agent, ATH and fumed silica are rendered hydrophobic, and they interact with polysiloxanes thus enhancing their dispersibility and reinforcing effect. These effects are evident from the physical and electrical properties of silicone rubber prepared. Thus dielectric strength of greater than about 300 volts per mil (vpm), tracking resistance of greater than about 100 minutes as measured by American Standard Testing Method (ASTM) test procedure number D2303, tracking resistance of greater than about 3 kilovolt (KV) as measured by the International Electrochemical Commission (IEC) 587 procedure indicates that the composition has the desired electrical properties.

Desired physical properties are Tear B Resistance measured by ASTM test procedure D-624, as known to one skilled in the art, value of greater than about 50 pounds per inch (ppi) and tensile strength of greater than about 500 pounds per square inch as measured by ASTM test No. D-412. In the presence of higher loading of silane coupling agent, the products prepared showed higher tensile strength and increased tracking/erosion resistance. Furthermore, due their ability to get coated on to the filler surface, the crape hardening of these rubbery products are minimized. Additionally these coupling agents act as adhesion promoters and improve the bonding of silicone rubber to the glass-fiber core of the insulator during the molding processes. Use of higher amounts of silane coupling agents in the instant compositions are however not recommended as the compositions tend to stick to the molds during the molding operations, thereby making the release of finished parts from the molds difficult. The preferred coupling agents are represented by structures represented by:
R⁴R⁵Si(OR⁵)₂ Formula II
R¹Si(OR²)₃ Formula III
R⁴R⁵Si(OOCR⁵)₂ Formula IV
or
R⁴Si(OOCR⁵)₃ Formula V
wherein R⁴ and R⁵ independently at each occurrence represent a C₁₋₆ alkyl group, phenyl group, or C₂₋₆ alkenyl groups.

To cure the above compositions and to obtain rubbery elastomeric parts for HV insulators, an organic peroxide, or a combination of several peroxides can be used. The organic peroxides known to one skilled in the art can be used in the compositions of the present invention. Illustrative examples are diacyl peroxides, ketone peroxides, peroxy esters, dialkyl peroxides, peroxyketals, peroxycarbonates, and tertiary alkyl hydroperoxides.

Other optional additives used in the compositions of the present invention are coloring agents and pigments. Illustrative examples are carbon black, red iron oxide, yellow iron oxide, black iron oxide, and TiO₂, which provide specific colors to the insulators. Mold release agents such as silicone fluids or metal stearates such as magnesium, calcium or aluminum stearate an also optionally used.

All the products prepared showed superior physical properties. The Shore A hardness (measured by ASTM test No. D-2240) of the products were between 60-80 and Tensile Strength were greater than 500 psi. Products also had higher percent (%) Elongation values and Tear B resistance. These physical properties are not critical to the performance of the finished insulators, however the presence of larger Elongation value and higher Tear resistance in heat-cured insulator parts help to obtain defect free products during the insulator manufacture. Furthermore Tensile strength and Shore A hardness provide the mechanical strength necessary for the insulators.

Silicone Elastomers that are used in out-door insulator applications should provide adequate dielectric strength to withstand the breakdown due to high voltage. Compositions of the present invention have Dielectric Strength values greater than about 300 vpm. Furthermore, these product showed very good flame retardancy which is necessary to withstand fires that could occur due to flash overs.

For molding applications it has been found that products with increased William's Plasticity, preferably above 300 can be easily molded. These processes included compression, transfer, or injection molding operations. When the plasticity values are very low, especially under 250, the weather sheds made had air entrapments resulting in some void formation in the finished parts obtained from the compression molding operations. For extrusion operations, where silicone rubber is extruded onto fiber glass rod in the form of sheath, lower plasticities are preferred. Lower the plasticity easier was to extrude. However, at much lower plasticity values, good dispersion of ATH and other fillers with silicone gums become difficult. For products used in extrusion operations preferred William's plasticity range was between 250-350. Furthermore, presence of high level of silane coupling agents provides better adhesion of rubber to the glass reinforced fiber rods used in the insulator, but presence of increased levels of coupling agents rendered the finished insulator parts to stick on to the molds, especially during transfer and injection molding operations and making the parts difficult to remove from the molds. As such it is preferred that the silane coupling agent level be at 0.25-1 part for each 100 part of silicone gums used in these products. We have also found that by employing mixed peroxide systems, instead of one type of peroxide, the cure speed is significantly improved.

### EXPERIMENTAL DETAILS

Sample Preparation

A kneader, such as a Banbury mixer, was charged with silicone gums followed by the liquid additives, pigments and mixed for several minutes. Inorganic fillers were then added in small portions, while mixing, to obtain a homogeneous product. The product was discharged and milled on a two roll mill, and filtered through a 150 mesh screen by extrusion. All the formulations as described below were made in a similar manner.

Tracking and Erosion Resistance Measurements

The compositions were tested for tracking and erosion resistance per modified ASTM D2303 or IEC 587 using cured 2″×5″×0.25″ slabs. A test solution comprising 0.02% alkylphenolpolyethoxylate surfactant (sold as Triton® X-100 by Rohm and Haas Co.), as the wetting agent, and 0.1% ammonium chloride solutions having resistivity of 330 ohms-cms was used as the contaminant. This test solution mimics the contamination conditions encountered by out door insulators.

For ASTM D2303 testing the flow rate of the contaminant solution was 0.3 ml/min and the voltage was maintained at 3.0 KV. Time track 1″ or time to erode 1 cm area, which ever occur first were determined.

For IEC 587 testing, five samples were tested at constant voltages from 3.5 KV up to 6.0 KV for 6 hours. The constant tracking voltage that samples passed was the highest voltage withstood by all five specimens for 6 h without failure. The end point of the test or failure mode of the test was when the current in the high voltage circuit through the specimen exceeds 60 mA or when the track reaches a mark on the specimen surface 25 mm from the lower electrode.

Hydrophobicity Recovery Measurements

Hydrophobicity of a silicone rubber surface and time to recover the hydrophobicity after the surface is treated with corona measures the ability of the surface to repel water droplets. Hydrophobicity and hydrophobicity recovery was measured using cured sheets (6″×6″×0.075″ in size) by measuring the change of water contact angle, before and after the sheets were subjected to corona treatment. The initial contact angle was measured using a 1 micro liter water droplets using a goniometer setup. After taking several measurements, 40 strokes corona was applied at 15 mil gap and the hydrophobicity recovery was measured by monitoring the contact angle of the 1 micro liter water droplets over a period of several days until there was no change in the contact angle. This time is reported as hydrophobicity recovery time. The desired hydrophobicity recovery time is up to 24 hours.

The present invention is further illustrated by the following examples.

### EXAMPLE 1

Following example describes the formulation of silicone heat-cured rubber product suitable for molding type applications in high voltage (HV) insulator production.

40 parts of diorganopolysiloxane gum [having a viscosity of (20-30 million cps) consisting of 99.77 mole % dimethylsiloxane units and 0.23% methylvinylsiloxane units], 60 parts of diorganopolysiloxane gum [having viscosity (30-120 million cps viscosity) consisting of 99.02 mole % dimethylsiloxane units and 0.08 mole % methylvinylsiloxane units], 2 parts of dimethylsiloxane oligomer end-blocked with silanol groups and having viscosity of 30 cps, 0.5 parts vinyltriethoxy silane (VTES), 35 parts of fumed silica treated with dimethyl tetra-cyclopolysiloxane having specific surface area of 200 m²/g, 120 parts of alumina trihydrate (ATH) having average particle diameter of 1 micron, and 35 parts of ground quarts having average particle diameter of 10 micron, were fed into a kneader mixer (Banbury mixer) and kneaded to a homogeneous mixture at ambient temperature. This mixture was added with 0.3 parts of Aluminum Stearate (optional), 0.88 black silicone gum based color master batch (50% carbon black) and 1.25 parts 2,5-dimethyl(t-butylperoxy)hexane peroxide and mixed well using a kneader or in a two roll mill to obtain a homogeneous product which was compression molded at 177° C. for 15 min. Some physical properties and electrical properties of the composition are listed in Table I.

TABLE I

| | |
|---|---|
| Shore A Hardness | 70 |
| Tensile Strength, (psi) | 854 |
| % Elongation | 188 |
| Tear B Resistance, (ppi) | 85 |
| Specific Gravity | 1.56 |
| Dielectric Strength, (vpm) | 525 |
| Tracking Resistance (min) (ASTM D2303) | 300 |
| Tracking Resistance (IEC 587) | 4.5 KV |
| Hydrophobicity Recovery (h) | 24 |

Variation of ATH Loading. Several products made in this manner by varying the ATH loading from 85 parts to 135 parts per 100 parts of silicone gums. To maintain the Shore A hardness around 70, the desired range being from 60 to 80, the high vinyl and low vinyl gum ratios were changed accordingly, and ground quarts and fumed silica levels were maintained to obtain the specific gravity around 1.5. All these samples had >100 min tracking resistance per ASTM D2303 and passed 4.5 KV per IEC 587.

Evaluation of Different Types of ATH:

The above Example A was repeated with several ATH (AL₂O₃.3H₂O) samples from different sources, namely Hydral® 710, PGA from ALCOA; Martinal® OL 104 and OL 107 from Martinswerk; 714K and 712K from Aluchem Inc.; and Micral® 9400 and 1500 from J. M. Huber. All the products are Al₂O₃.3H₂O samples marketed under the different tradenames. They gave similar properties including hydrophobicity recovery and tracking resistance per ASTM D2303 between 140-450 min and passed 4.5 KV per IEC 567.

Evaluation of the Effect of ATH and Silane Coupling Agent (VTES) Loading:

Additional compositions were made according to the procedure in Example 1 above, by varying the silane coupling agent (VTES), fumed silica and ATH. All the other ingredients were kept constant. Table II shows the results obtained for different properties. At higher silane coupling agent concentrations (VTES), and higher ATH loading the product showed increased times to failure in tracking and erosion testing.

TABLE II

| | | | Tensile | Dielectric | Track/Erosion |
|---|---|---|---|---|---|
| VTES | ATH | Shore A | Strength | Strength | Resistance |
| parts | parts | Hardness | psi | vpm | (min) |
| 1 | 100 | 75 | 989 | 477 | 380 |
| 0.5 | 100 | 73 | 915 | 457 | 334 |
| 1 | 100 | 72 | 975 | 430 | 360 |
| 0.5 | 100 | 71 | 870 | 477 | 292 |
| 1 | 85 | 74 | 1050 | 462 | 343 |
| 0.5 | 85 | 72 | 969 | 484 | 182 |
| 1 | 85 | 71 | 1028 | 476 | 287 |
| 0.5 | 85 | 69 | 903 | 477 | 127 |

### EXAMPLE 2

Following example describes the formulation of silicone heat-cured rubber product especially suitable for extrusion type applications in HV Insulator production.

94 parts of diorganopolysiloxane gum [having viscosity (10-20 million cps viscosity) consisting of 99.77 mole % dimethylsiloxane units and 0.23% methylvinylsiloxane unit], 6 parts of diorganopolysiloxane gum [having viscosity (10-20 million cps viscosity) consisting of 100 mole % dimethylsiloxane units], 2 parts of dimethylsiloxane oligomer end-blocked with silanol groups and having viscosity of 30 cps, 1 part vinyltriethoxy silane, 38 parts of fumed silica treated with dimethyl tetra-cyclopolysiloxane having specific surface area of 200 m2/g, and 135 parts of alumina trihydrate having average particle diameter of 1 micron were fed into a kneader mixer and kneaded to a homogeneous mixture at ambient temperature. To this mixture was added with 0.3 parts of Aluminum Stearate (an optional ingredient), 0.88 black silicone gum based color master batch (50% carbon black), and 1.4 parts 2,4-dichlorobenzoyl peroxide, and mixed well either in the same kneader or in a two roll mill to obtain a homogeneous product, which was compression molded at 135° C. for 10 min. Different physical properties and electrical properties are given in Table III.

TABLE III

| | |
|---|---|
| Shore A Hardness | 77 |
| Tensile Strength, (psi) | 1046 |
| % Elongation | 208 |
| Tear B Resistance, (ppi) | 87 |
| Dielectric Strength, (vpm) | 497 |
| Tracking Resistance (min) (ASTM D2303) | 480 |
| Tracking Resistance (IEC 587) | 4.5 KV |
| Hydrophobicity Recovery (h) | 24 |

What is claimed is:

1. A composition comprising:
(a) from about 15% to about 50%, by weight of the total composition, of a silicone polymer;
(b) from about 5% to about 30% by weight of the total composition of a reinforcing filler;
(c) from about 20% to about 70% by weight of the total composition of an anti-tracking agent and a flame retardant;
(d) from about 0.01% to about 1% by weight of the total composition of a coupling agent;
(e) from about 0.1% to about 5% by weight of the total composition of a curing agent;
(f) up to about 20% by weight of the total composition of an extending filler; and
(g) from about 0.1% to about 5% by weight of the total composition of at least one processing fluid.

2. A composition of claim 1 wherein:
(a) the silicone polymer comprises from about 25% to about 40%;
(b) the reinforcing filler comprises from about 8% to about 20%; and
(c) the anti-tracking and the flame retardant comprises from about 25% to about 60%.

3. A composition of claim 2 wherein the silicone polymer is represented by recurring units of Formula I 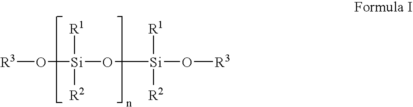
wherein:
R¹ independently at each occurrence represents C₁₋₄ alkyl, or C₂₋₄ alkylene;
R² independently at each occurrence represents C₁₋₄ alkyl, C₁-C₄ haloalkyl, or C₂₋₄ alkylene;
R³ independently at each occurrence represents H, C₁₋₁₀ alkyl, C₂₋₄ alkylene, C₄₋₆ cycloalkyl, C1-C4 haloalkyl, OH; and
n represents an integer from 1,000 to 20,000

4. A composition of claim 3 wherein
R¹ independently at each occurrence represents, CH₃ or CH═CH₂;
R² independently at each occurrence represents CH₃, CH₂CH₂CF₃, or CH═CH₂;
R³ at each occurrence represents CH₃, CH═CH₂, OH, or CH₂CH₂CF₃; and
n represents an integer from about 4,000 to about 10,000.

5. A composition of claim 3 wherein the vinyl content of the silicone polymer ranges from about 0.05% to about 0.5% by weight of the silicone polymer.

6. A composition of claim 5 wherein the reinforcing filler is fumed silica, precipitated silica, or carbon black having a surface area of from about 50 to about 400 m²/g.

7. A composition of claim 5 wherein the coupling agent is vinyltriethoxysilane (VTES), or vinyltrimethoxysilane, methacrylpropyltrimethoxy silane.

8. A composition of claim 5 wherein the curing agent is a peroxide based curing agent.

9. A composition of claim 8 wherein the curing agent is a diacylperoxide, ketone peroxide, and dialkyl peroxide.

10. A composition of claim 5 wherein the extending filler is ground quartz, calcium carbonate, magnesium silicate, or magnesium aluminum silicate.

11. A process of claim 5 wherein the processing fluid is a methyl or hydroxy terminated polydimethyl siloxane.

12. A composition of claim 5 further comprising a mold release agent, a coloring agent, or a heat resistive agent.

13. A composition of claim 12 wherein the mold release agent is a silicone fluid, magnesium, aluminum, or cerium stearate.

14. A composition of claim 13 wherein the heat resistive agent is a cerium octoate, cerium hydroxide, magnesium oxide, cerium oxide, or magnesium hydroxide.

15. A composition of claim 1 wherein upon heat curing the composition, the heat cured composition comprises a high voltage insulating composition.

16. A process for making a high voltage insulating composition, the process comprising heat curing the composition of claim 1.
